(19) United States
(12) Patent Application Publication
(10) Pub. No.: US 2015/0058152 A1
(43) Pub. Date: Feb. 26, 2015

(54) SYSTEM AND METHOD FOR SEARCHING AUCTION DATA

(71) Applicant: vAuto, Inc., Oak Brook, IL (US)

(72) Inventors: Dale Pollak, Oak Brook, IL (US); Todd Kinzle, Oak Brook, IL (US)

(21) Appl. No.: 14/465,220

(22) Filed: Aug. 21, 2014

Related U.S. Application Data
(60) Provisional application No. 61/868,374, filed on Aug. 21, 2013.

(51) Int. Cl. G06Q 30/08

(52) U.S. Cl. CPC G06Q 30/08
USPC 705/26.3

(57) ABSTRACT

The present disclosure relates to computer-implemented systems and methods for searching auction data. According to one or more embodiments of the disclosure, a method is provided. The method may include by a server comprising one or more processors, one or more vehicle purchasing parameters input by a dealer. In addition, the method may include accessing auction data from a plurality of vehicle auctions, the auction data associated with one or more vehicles being auctioned at one or more of the plurality of vehicle auctions. Furthermore, the method may include determining from the auction data, based at least in part on the one or more vehicle purchasing parameters, at least one potential vehicle, of the one or more vehicles, to purchase.

### CROSS-REFERENCE TO RELATED APPLICATIONS

This application claims the benefit of U.S. Provisional Application No. 61/868,374, filed Aug. 21, 2013, entitled “System and Method for Searching Auction Data,” the contents of which are hereby incorporated by reference.

### TECHNICAL FIELD

The present disclosure generally relates to auctions, and in particular, to searching auction data.

### BACKGROUND

Dealers frequently participate in vehicle auctions to purchase vehicles they feel they will be able to sell at a profit. With the advent of online vehicle auctions, dealers may be able to participate in multiple auctions simultaneously to fill their inventory needs. Thus, dealers may desire tools that facilitate relatively quick research of vehicles being auctioned at various auctions in order to make an informed decision regarding a potential purchase of one of the vehicles.

### BRIEF DESCRIPTION OF THE DRAWINGS

Reference will now be made to the accompanying figures and diagrams, which are not necessarily drawn to scale, and wherein:

FIG. 1 shows a system for searching auction data according to one or more example embodiments.

FIG. 2 shows a block diagram illustrated a data flow for searching auction data according to one or more example embodiments.

FIG. 3 shows a user interface for displaying auction data, according to one or more example embodiments.

FIG. 4 shows a flow diagram of an example environment suitable for implementing methods for searching auction data, according to one or more example embodiments.

### DETAILED DESCRIPTION

In the following description, numerous specific details are set forth. However, it should be understood that embodiments of the present disclosure may be practiced without these specific details. In other instances, well-known methods, structures, and techniques have not been shown in detail in order not to obscure an understanding of this description. References to “one embodiment,” “an embodiment,” “example embodiment,” “various embodiments,” and so forth indicate that the embodiment(s) of the present disclosure so described may include a particular feature, structure, or characteristic, but not every embodiment necessarily includes the particular feature, structure, or characteristic. Furthermore, the repeated use of the phrase “in one embodiment” does not necessarily refer to the same embodiment, although it may.

As used herein, unless otherwise specified, the use of the ordinal adjectives “first,” “second,” “third,” etc., to describe a common object merely indicates that different instances of like objects are being referred to and are not intended to imply that the objects so described must be in a given sequence, either temporally, spatially, in ranking, or in any other manner.

As used herein, unless otherwise specified, the term “user device” refers, in general, to an electronic communication device, both wired and wireless, and more particularly to one or more of the following: a portable electronic device, a telephone (e.g., cellular phone, smartphone), a computer (e.g., laptop computer, tablet computer, desktop computer, wearable computer), a portable media player, a personal digital assistant (PDA), a kiosk computer for public use, or any other electronic device having a networked capability.

As used herein, unless otherwise specified, the term “server” may refer to any computing device having a networked connectivity and configured to provide one or more dedicated services to clients, such as a mobile device. The services may include storage of data or any kind of data processing. One example of a central server may include a web server hosting one or more web pages. Some examples of web pages may include social networking web pages. Another example of a server may be a cloud server that hosts web services for one or more computer devices.

As used herein, unless otherwise specified, the term “web page” may correspond to one or more web pages as part of one or more websites.

The present disclosure relates to computer-implemented systems and methods for searching auction data. According to one or more embodiments of the disclosure, a method is provided. The method may include receiving, by a server comprising one or more processors, one or more vehicle purchasing parameters input by a dealer. In addition, the method may include accessing auction data from a plurality of vehicle auctions, the auction data associated with one or more vehicles being auctioned at one or more of the plurality of vehicle auctions. Furthermore, the method may include determining from the auction data, based at least in part on the one or more vehicle purchasing parameters, at least one potential vehicle, of the one or more vehicles, to purchase.

According to one or more embodiments of the disclosure, a device is provided. The device may include at least one processor and at least one memory. The at least one memory may store instructions that cause the at least one processor to receive one or more vehicle purchasing parameters associated with a vehicle seller/buyer and one or more inventory parameters associated with an inventory of the vehicle seller. The instructions may further cause the at least one processor to receive, in real-time, auction data from a plurality of online vehicle auctions, the auction data associated with one or more vehicles being auctioned at one or more of the plurality of online vehicle auctions. Furthermore, the instructions may cause the at least one processor to filter the auction data, based at least in part on the one or more vehicle purchasing parameters and the one or more inventory parameters, into a subset of the one or more vehicles. The instructions may further cause the at least one processor to determine at least one potential vehicle, from the subset, to purchase.

According to one or more embodiments of the disclosure, a non-transitory computer readable medium is provided. The non-transitory computer-readable medium may have embodied thereon instructions executable by one or more processors. The instructions may cause the one or more processors to receive one or more vehicle purchasing parameters associated with a vehicle seller/buyer and one or more vehicle purchase recommendations associated with an inventory of the vehicle seller. The instructions may further cause the one or more processors to receive, in real-time, auction data from a plurality of online vehicle auctions hosted by two or more auction entities, the auction data associated with one or more vehicles being auctioned at the plurality of online vehicle auctions. Furthermore, the instructions may cause the one or more processors to filter the auction data, based at least in part on the one or more vehicle purchasing parameters and the one or more vehicle purchase recommendations, into a subset of the one or more vehicles. The instructions may further cause the one or more processors to determine at least one potential vehicle, from the subset, to purchase.

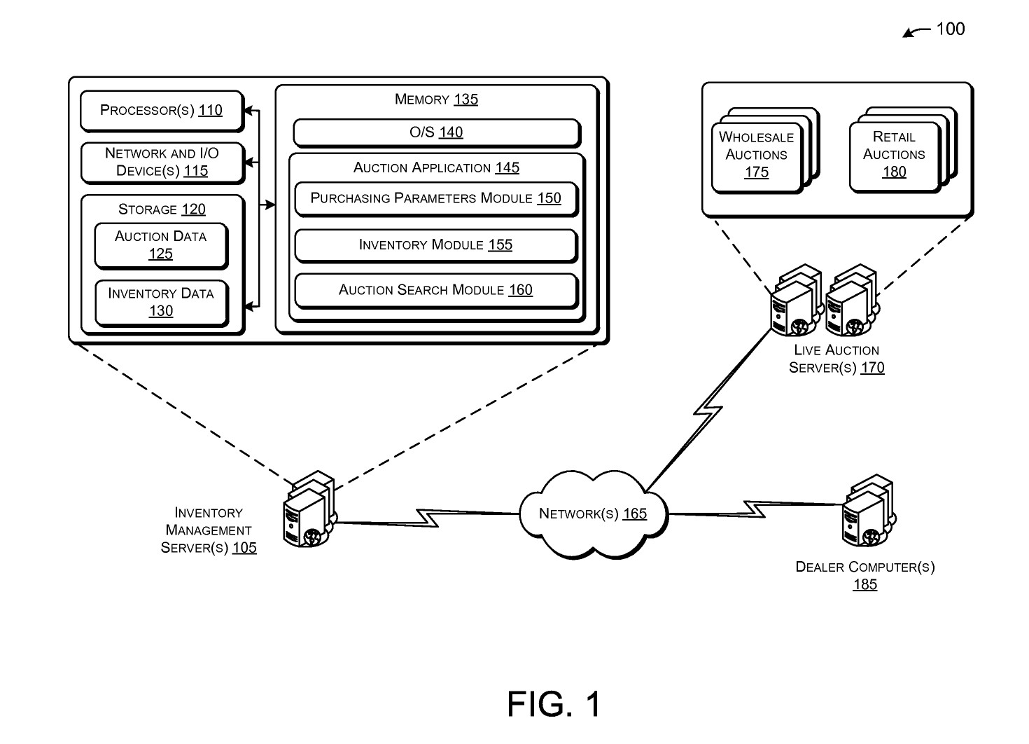

The above principles, as well as perhaps others, are now illustrated with reference to FIG. 1, which depicts a system 100 for searching auction data. The system 100 may include one or more inventory management servers 105, one or more live auction server(s) 170, and one or more dealer computer(s) 185 in communication with each other through a network 165, such as the Internet or the like.

According to some embodiments, the inventory management server(s) 105 may include one or more computer processors 110, Input/Output (I/O) devices 115, storage 120, and memory 135. The computer processors 110 may comprise one or more cores and may be configured to access and execute (at least in part) computer-readable instructions stored in the memory. The one or more computer processors may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The user device 102 may also include a chipset (not shown) for controlling communications between the one or more processors and one or more of the other components of the user device 102. In certain embodiments, the user device 102 may be based on an Intel® architecture or an ARM® architecture, and the processor(s) and chipset may be from a family of Intel® processors and chipsets. The one or more processors may also include one or more application-specific integrated circuits (ASICs) or application-specific standard products (ASSPs) for handling specific data processing functions or tasks.

The network and I/O devices 115 may include one or more input devices such as keyboards, mice, pens, voice input devices, touch input devices, etc., and output devices 126, such as displays, speakers, printers, etc. In addition, the network and I/O devices 115 may also include various devices that facilitate communication, through one or more communication interfaces, between the inventory management server(s) 105 and other devices in the system 100. As such, the communication interfaces may include, but are not limited to: personal area networks (PANs), wired local area networks (LANs), wireless local area networks (WLANs), wireless wide area networks (WWANs), and so forth. The inventory management server(s) 105 may be coupled to the network 165 via a wired connection. However, the wireless system interfaces may include the hardware and software to broadcast and receive messages either using, for example, the Wi-Fi Direct Standard (see e.g., Wi-Fi Direct specification published in October 2010) and/or the IEEE 802.11 wireless standard (see e.g., IEEE 802.11-2007, published Mar. 8, 2007; IEEE 802.11n-2009, published October 2009), or a combination thereof. The wireless system (not shown) may include a transmitter and a receiver or a transceiver (not shown) capable of operating in a broad range of operating frequencies governed by the IEEE 802.11 wireless standards. The communication interfaces may utilize acoustic, radio frequency, optical, or other signals to exchange data between the inventory management server(s) 105 and another device such as an access point, a host computer, a server, a router, a reader device, and the like. Furthermore, the network 165 may include, but is not limited to: the Internet, a private network, a virtual private network, a wireless wide area network, a local area network, a metropolitan area network, a telephone network, and so forth.

Additionally, the memory 135 may include one or more computer-readable storage media (CRSM). In some embodiments, the memory 135 may include non-transitory media such as random access memory (RAM), flash RAM, magnetic media, optical media, solid state media, and so forth. The memory 135 may be volatile (in that information is retained while providing power) or non-volatile (in that information is retained without providing power). Additional embodiments may also be provided as a computer program product including a transitory machine-readable signal (in compressed or uncompressed form). Examples of machine-readable signals include, but are not limited to, signals carried by the Internet or other networks. For example, distribution of software via the Internet may include a transitory machine-readable signal.

The storage 120 may include any type of storage device suitable for storing information such as auction data 125 and inventory data 130. For example, the storage 120 may be a hard disk drive, tape drive, solid-state drive, flash memory, an optical drive, network attached storage, and/or any other type of storage component.

Additionally, the memory 135 may store an operating system 140 that includes a plurality of computer-executable instructions that may be implemented by the computer processors 110 to perform a variety of tasks to operate the interface(s) and any other hardware installed on the inventory management server(s) 105. The memory 135 may also store content that may be displayed by the inventory management server(s) 105 or transferred to other devices (e.g., headphones) to be displayed or played by the other devices. The memory 135 may also store content received from the other devices. The content from the other devices may be displayed, played, or used by the inventory management server(s) 105 to perform any necessary tasks or operations that may be implemented by the computer processors 110 or other components in the inventory management server(s) 105.

According to certain embodiments, the one or more live auction servers 170 may be associated with wholesale auction data 175 and one/or one or more retail auction data 180. Wholesale auction data 175 may be associated with one or more wholesale auction entities, wholesale dealers, and/or the like, and may relate to live and/or online auctions. Similarly, retail auctions data 180 may be associated with one or more retail auction entities, retail dealers, or the like, and may be live and/or online auctions. To this end, live auction servers 170 may receive, collect, and/or store sales information and/or user behavior information from the wholesale auctions 175 and/or the retail auctions 180.

With reference to the inventory management server 105, according to one or more embodiments, the memory 135 may also store an auction application 145. The auction application 145 may be configured to receive and/or retrieve auction data 125 from the one or more live auction servers 170. As such, the auction application 145 may be operable to store the auction data 125 in the storage 120, such as in a database (not pictured) for example. In some embodiments, the auction application 145 may periodically communicate with the live auction server(s) 170 to update the auction data 125 with real-time information associated with the live auction server(s) 170. Auction data 125 may be associated with one or more vehicles being auctioned at one or more online auctions hosted by the live auction server(s) 170. As such, auction data 125 may include, but is not limited to, information associated with vehicle price, bid amount, type, make, model, color, condition, grade, and/or the like. Furthermore, in some embodiments, the auction data 125 may be retrieved from, and therefore associated with, multiple different online auctions. In other words, the auction application 145 may be configured to aggregate information from various auction sites hosted by the live auction server(s) 170 (e.g., Manheim, ADESA, OPENLANE, etc.). In addition, the auction data 125 may be associated with vehicles being auctioned at multiple respective auction locations. In other embodiments, rather than storing and periodically updating auction data 125, the auction application 145 may be configured to access auction information directly from the live auction server(s) 170.

In one or more embodiments, the auction application 145 may include a purchasing parameters module 150, an inventory module 155, and an auction search module 160. Broadly, such components may facilitate a dealer's (and/or any other type of vehicle retailer's, buyer's, or seller's) search for one or more potential vehicles to purchase and/or bid at one or more online auctions. Since the online auctions may include different auctions in different locations, the auction application 145 may therefore facilitate the search across multiple auctions hosted by respective live auction server(s) 170.

Thus, to initiate a search, a user (e.g., a user of the dealer computer(s) 185, such as a dealer) may input one or more purchasing parameters into the auction application 145. As such, the purchasing parameters module 150 may be configured to receive the one or more vehicle purchasing parameters. The vehicle purchase parameters may include, but are not limited to, vehicle type, make, model, color, condition, grade, and/or the like and may also include pricing information such as wholesale price, potential retail price, acceptable profit margins, preferred markup percentages, and/or the like.

In addition to the vehicle purchasing parameters, the auction application 145 may also consider vehicle inventory associated with the user and/or dealer computer(s) 185. Therefore, the inventory module 155 may be configured to receive, retrieve, and/or otherwise access inventory data 130 associated with one or more vehicle inventories of the user or dealer computer(s) 185. In some embodiments, both the auction data 125 and the inventory data 130 may be stored on the inventory management server(s) 105 in storage 120. However, it will appreciated that the auction data 125 and the inventory data 130 may also be stored in the dealer computer(s) 185 and/or any other location or component. Inventory data 130 may include any type of vehicle data associated with one or more vehicles in inventories of a dealer(s) such as vehicle quantity, sale price, make, model, year, historical sales data, market conditions (e.g., past, present, and future market conditions), sales volumes, user searches, market day supply, average retail profitability, vehicle availability, vehicle desirability, and/or the like.

In certain embodiments, the inventory module 155 may be configured to determine, based at least in part on the inventory data 130, one or more vehicle purchase recommendations for the dealer and/or dealer computer(s) 185. The vehicle purchase recommendations may inform the dealer which vehicles, and/or at what price, the dealer should consider purchasing. In some embodiments, the inventory module 155 may also be configured to analyze the auction data 125 in addition to the inventory data 130. Such analysis may enable the inventory module 155 to identify particular vehicles that are being auctioned and/or that will be soon auctioned by the live auction server(s) 170. Thus, the inventory module 155 may determine vehicle purchase recommendations from the subset of those particular vehicles that are being auctioned or that are soon to be auctioned. In this manner, the inventory module 155 may generate vehicle purchase recommendations, for actual vehicles that may be auctioned or that may soon be auctioned, to fill a dealer's inventory objectives.

Thus, the auction application 145 may be configured to access auction data 125 and inventory data 130. According to one or more embodiments, the auction search module 160 may be configured to perform searches and/or otherwise determine, based on the auction data 125 and/or inventory data 130 (e.g., vehicle purchase recommendations), one or more potential vehicles to purchase from a plurality of online auctions. To this end, the auction search module 160 may be configured to perform associated searches across one or more auctions hosted by the live auction server(s) 170. For example, a dealer may decide to search online auctions in order to purchase one or more vehicles. Additionally, the dealer may have certain purchasing parameters associated with the search, and the dealer may also desire the search to take into account the dealer's inventory needs. Thus, the dealer may input vehicle purchasing parameters in the deal computer(s) 185, and the vehicle purchasing parameters may then be sent to the purchasing parameters module 150 of the auction application 145. The dealer may also provide the inventory module 155 with inventory data 130, and the inventory module 155 may generate vehicle purchase recommendations based on the inventory data 130. The purchasing parameters module 150 and the inventory module 130 may then provide the vehicle purchasing parameters and the vehicle purchase recommendations, respectively, to the auction search module 160. As such, the auction search module 160 may be configured to perform a search of the auction data 125 based at least in part on the vehicle purchasing parameters and the vehicle purchase recommendations. The auction search module 160 may then return search results, which indicate, to the dealer and/or dealer computer(s) 185, one or more potential vehicles to purchase from the online auctions hosted by the liver auction server(s) 170.

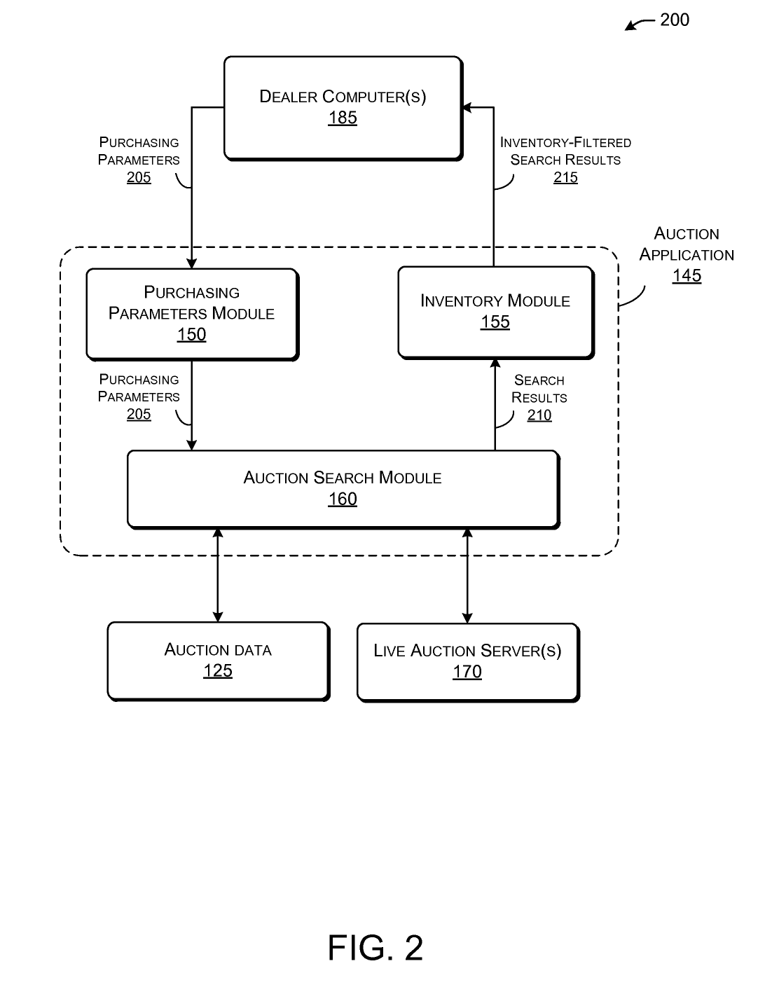

FIG. 2 provides a block diagram illustrating a data flow 200 for searching auction data in accordance with one or more example embodiments. According to certain embodiments illustrated by the data flow 200, a user of the dealer computer 185 may send/submit/transmit one or more purchasing parameters 205 to the auction application 145. As previously discussed, such parameters may include vehicle type, make, model, color, condition, grade, price, and/or the like. The purchasing parameters module 150 may be configured to receive the purchasing parameters 205 and provide the purchasing parameter 205 to the auction search module 160. For instance, the user may provide purchasing parameters 205 that include black Hondas in good condition. To this end, the auction search module 160 may be configured to perform a search, based at least in part on the purchasing parameters 205, for one or more potential vehicles (e.g., black Honda in good conditions) for the dealer to purchase.

In some implementations, the auction search module 160 may be configured to access auction information, such as from auction data 125 stored on the inventory management server(s) 105, and/or directly from the live auction server(s) 170. As such, the auction search module 160 may access auction information from a plurality of different auctions, and/or from multiple auction locations. Thus, the auction search module 160 may be able to determine one or more potential vehicles for purchase, across multiple different auctions at multiple locations (e.g., auctions hosted by different auction entities), according to the purchasing parameters input by the dealer computer(s) 185. Continuing with the above example, the auction search module 160 may access auction information with respect to black Hondas in good condition being auctioned at one or more first auctions and one or more second auctions. Furthermore, the respective first and second auctions may be located in a variety of different cities and/or states. Thus, the user may be able to determine one or more black Hondas in good condition that are being auctioned, and/or that will soon be auctioned, at the respective first and second auctions.

Moreover, once the auction search module 160 has determined the appropriate search results 210 (e.g., the one or more black Hondas in good condition), these search results 210 may be provided to the inventory module 155. The inventory module 155 may be configured analyze the inventory data 130 and filter the search results 210 based at least in part on such analysis of the inventory data 130. For example, the inventory module 155 may be configured to analyze the inventory data 130 associated with one or more vehicles in the dealer/dealer computer's 185 inventory. As described above, the inventory data may include, but are not limited to, information associated with vehicle quantity, sale price, make, model, year, historical sales data, market conditions (e.g., past, present, and future market conditions), sales volumes, user searches, market day supply, average retail profitability, vehicle availability, vehicle desirability, and/or the like. To this end, the user of the dealer computer(s) 185 may be able to set and/or select certain preferences with respect which types of inventory data 130 the inventory module 155 is to consider. Based at least in part on selected preferences, the inventory module 155 may be configured to provide one or more vehicle purchase recommendations, which indicate one or more vehicles that the user should consider purchasing. Based at least in part on the vehicle purchase recommendations, the inventory module 155 may filter the search results 210 for vehicles that correspond to the recommendations.

For instance, a user may configure the auction application 145 and/or inventory module 155 to analyze market day supply and average retail profitability for one or more vehicles associated with the inventory data 130. Based on the inventory data 130 (e.g., analysis of market day supply and average retail profitability), the inventory module 155 may determine one or more recommendations for the user to purchase certain makes, models, model years, mileage, and/or cost. For example, the inventory module 155 may determine recommendations for Honda Accords and Honda Civics. As such, the inventory module 130 may filter the search results 210, which as discussed above, may include black Hondas in good condition being auctioned at the respective first and second auctions. The inventory module 155 may then be configured to provide the inventory-filtered search results 215 to the user/dealer computer(s) 185. Continuing with the example above, the user may receive inventory-filtered search results 215, which may include black Honda Accords and/or black Honda Civics, in good condition, that are being auctioned and/or that are soon to be auctioned at respective first and second auctions.

It should be noted that other embodiments, aside from those illustrated in FIG. 2, are also possible for performing searches across multiple online auctions. For instance, in some embodiments, the auction search module 160 may be configured to first perform a search according to one or more vehicle purchase recommendations provided by the inventory module 155. Then, the purchasing parameters module 150 may be configured to filter the results of the search according to the purchasing parameters 205 provided by the user/dealer computer(s) 185. Alternatively, the auction search module 160 may be configured to consider both the purchasing parameters 205 and the vehicle purchase recommendations in performing the search.

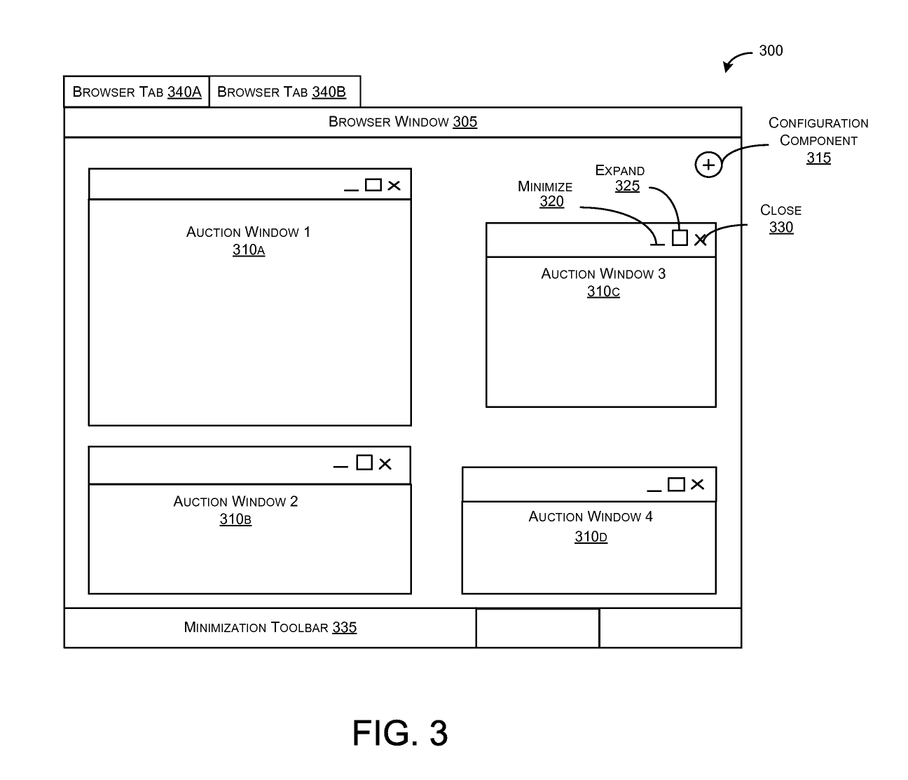

Turning now to FIG. 3, a block diagram of a user interface 300 for searching auction data is provided according to one or more example embodiments. According to certain embodiments, the user interface 300 may be accessed within a browser or one or more browser windows 305. As illustrated in FIG. 2, the browser window 305 may include four auction windows (e.g., auction window 1 310A, auction window 2 310B, auction window 3 310C, and auction window 4 310D) although any number of auction windows is possible. Furthermore, while the positions of the auction windows 310A-D are illustrated according to a certain arrangement in FIG. 2, it should be appreciated that other positional arrangements of the auction windows 310A-D are also possible. Additionally, the auction windows 310A-D may be of any size and/or shape and may be adjusted according to user preference.

In some embodiments, the auction windows 310A-D may be configured to display live auctions (and/or vehicles being auctioned at live auctions) occurring at different auctions and/or different locations (e.g., auctions hosted by two or more different auction entities). For example, auction window 1 310A may display a live auction (e.g., an auction lane), for a first auction, occurring in Atlanta, Ga. while auction window 3 310C may display a live auction, for a second auction, occurring in Austin, Tex. To this end, the auction windows 310A-D may be configured to display auction data 125 associated with one or more vehicles being auctioned at the respective first and second auctions. Thus, a user of the user interface 300 may be able to browse certain attributes (e.g., via the display of the auction data 125) of vehicles being auctioned at the respective auctions, such as vehicle type, make, model, color, condition, grade, price, and/or the like.

The user interface 300 may also include a configuration component 315, which may facilitate a user's ability to add, remove, or configure/re-configure the auction windows 310A-D and/or other user interface components. For example, selecting the configuration component 315 may provide the user with an option to add a fifth auction window (not pictured) to display auction data 125 associated with a different auction from those displayed in auction windows 310A-D. In some implementations, the selecting the configuration component 315 may enable the user to adjust the currently displayed auction windows 310A-D. Thus, when the configuration component 315 is selected, a user may be permitted to configure a selected auction window 315A-D, such as by graphically repositioning e.g., moving) and/or resizing the display of the selected auction window 315A-D. After completing the repositioning and/or resizing, the reconfiguration may be saved (e.g., stick or automatically saved) for future accesses of the auction windows 315A-D.

In other embodiments, auction windows 310A-D may include individual configuration components in addition to, or in lieu of, the configuration component 315. For instance, the individual components may provide separate configuration features, including a minimize component 320, an expand component 325, and a close component 330. The close component 330 may be selected to close an auction window 310A-D to avoid unnecessary processing if the information provided by auction window 310A-D is no longer desired. In certain implementations, when an auction window 310A-D is minimized by the minimize component 320, an icon and/or any other graphical indication of the minimized auction window 310A-D may appear in the minimization toolbar 335. Furthermore, other types of information may also be displayed the minimization toolbar 335 and/or alongside the minimization toolbar 335. For instance, status information, notification information, messages, and/or the like, associated with respective online auctions, may also be displayed.

According to certain embodiment, the user interface 300 may also include a “tabbed” style interface configured to provide access to multiple instances of the browser window 305. In such implementations, the user interface 300 may include one or more browser tabs 340A-B, and respective browser tabs 340 may represent an instance of a browser window 305. To this end, each instance of the browser window 305 may provide access to a separate concurrently occurring auction. Thus, auction data 125 associated with respective auctions, some of which may be conducted by different auction companies at various geographical locations, may be displayed in respective browser tabs 340A-B. For example, browser tab 340A may display a first auction, in Atlanta, Ga., for a first auction entity while browser tab 340B may display a second auction, in Austin, Tex., for a second auction entity. A third browser tab (not illustrated) may display third auction, in Houston, also for the first auction entity. It should be noted that any number of browser tabs 340A-B representing any number of auctions are contemplated. Furthermore, in a “tabbed” style user interface 300, since respective browser tabs 340A-B represent respective auctions, the auction windows 310A-D for a respective browser tab 340A-B may only display information (e.g., auction data 125) for the respective auction identified by that respective browser tab 340A-B.

It should be noted that FIG. 3 merely illustrates one or more example embodiments of the user interface 300, and that other various other configurations of the user interface 300 are also possible. As such, some embodiments may provide for an Application Programming Interface (API) to users and/or third-parties. The API may enable a user and/or a third-party vendor to create additional components as desired. For example, a settings/preferences popup dialog box/window (not illustrated) may be displayed to a user for the user to fill out to configure each of the auction windows 310A-D. Potential settings for the auction windows 310A-D may include, but are not limited to: title, description, category, dependent components (i.e., other components required for the desired component to function properly), visible status (on/off), default size (width, height), default position (x, y), price, and billing type (e.g., once, monthly, per-transaction, free, etc.). In addition, display information (e.g., size, position) may be set by graphically configuring the auction windows 310A-D on the browser window 305 and/or may be entered as text in a popup dialog box (or any other data entry form desired by a system designer).

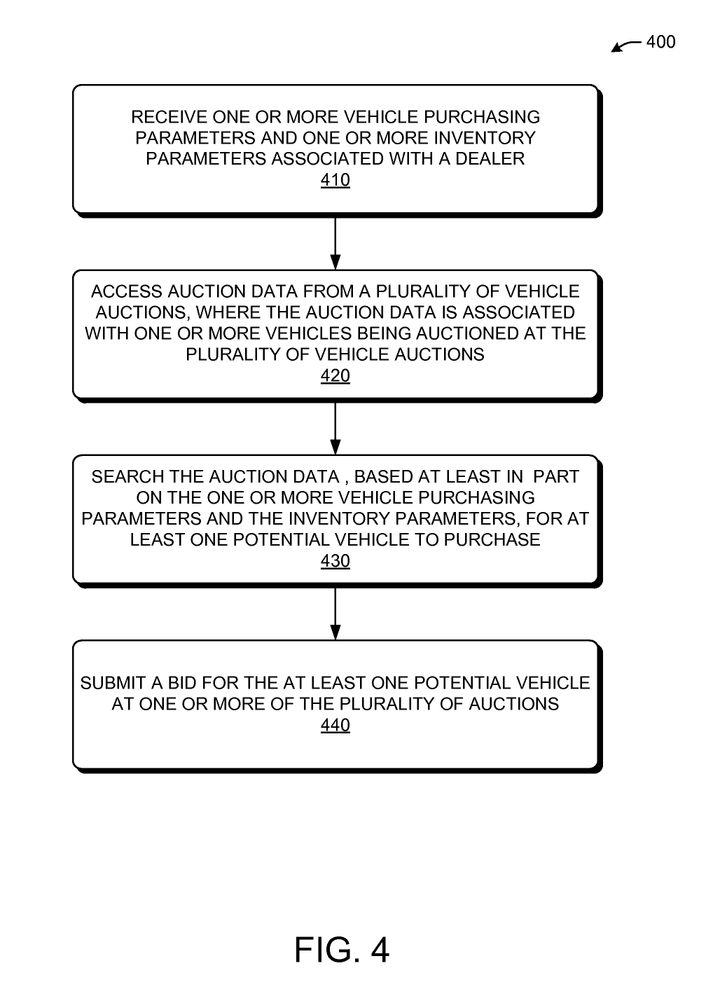

FIG. 4 provides a flow diagram that illustrates a method 400 for searching auction data according to one or more example embodiments. In block 410, an auction application 145 (e.g., via the purchasing parameters module 150) may receive one or more vehicle purchasing parameters from a dealer/dealer computer 185. In addition, the auction application 145 may also receive one or more inventory parameters and/or inventory data 130 (e.g., via the inventory module 155) associated with an inventory of the dealer/dealer computer 185. In certain embodiments, the one or more inventory parameters may include, or may be used to determine, one or more vehicle purchase recommendations to fill the dealer's inventory needs.

In block 420, the auction application 145 may be configured to access auction data 125 from a plurality of vehicle auctions (e.g., from live auction server(s) 170). To this end, the auction data 125 may be associated with one or more vehicles being auctioned at one or more of the plurality of auctions. In addition, in some implementations, the plurality of auctions may be hosted by two or more auction entities (e.g., auctions companies such as Manheim, ADESA, OPENLANE, etc.).

In block 430, the auction application 145 may be configured to search the auction data 125. For instance, the auction application 145 may determine, from the auction data 125 and based at least in part on the one or more vehicle purchasing parameters and the inventory parameters, at least one potential vehicle to purchase. In block 440, the auction application 145 may be configured to submit a bid for the at least one potential vehicle at one or more of the plurality of auctions. For example, the auction application 145 may identify the particular auction(s) at which of the plurality of auctions the at least one potential vehicle is being auctioned and submit a bid for the at least one potential vehicle at the appropriate auction(s).

Certain embodiments of the present disclosure are described above with reference to block and flow diagrams of systems and methods and/or computer program products according to example embodiments of the present disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the present disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the present disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the present disclosure have been described in connection with what is presently considered to be the most practical and various embodiments, it is to be understood that the present disclosure is not to be limited to the disclosed embodiments, but is intended to cover various modifications and equivalent arrangements included within the scope of the appended claims. Although specific terms are employed herein, they are used in a generic and descriptive sense only and not for purposes of limitation.

This written description uses examples to disclose certain embodiments of the present disclosure, including the best mode, and also to enable any person skilled in the art to practice certain embodiments of the present disclosure, including making and using any devices or systems and performing any incorporated methods. The patentable scope of certain embodiments of the present disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method, comprising:
receiving, by a computer comprising one or more processors, one or more vehicle purchasing parameters from by a dealer;
accessing auction data from a plurality of vehicle auctions, the auction data associated with one or more vehicles being auctioned at one or more of the plurality of vehicle auctions; and
determining from the auction data, based at least in part on the one or more vehicle purchasing parameters, at least one potential vehicle, of the one or more vehicles, to purchase.

2. The method of claim 1, wherein the plurality of vehicle auctions are hosted by two or more auction entities.

3. The method of claim 2, wherein in submitting the bid comprises:
identifying a first vehicle auction, from the plurality of vehicle auctions, that is auctioning the at least one potential vehicle; and
transmitting a bid, to the first vehicle auction, for the at least one potential vehicle for the vehicle auction.

4. The method of claim 1, further comprising receiving one or more inventory parameters associated with an inventory of the vehicle dealer.

5. The method of claim 4, further comprising generating one or more vehicle purchase recommendations based at least in part on the one or more inventory parameters.

6. The method of claim 5, wherein determining the at least one potential vehicle is further based at least in part on the one or more vehicle purchase recommendations.

7. The method of claim 4, wherein the one or more inventory parameters comprise at least one of: a sales volume, a market day supply, a retail profitability, or an availability of one or more inventory vehicles associated with the inventory.

8. The method of claim 1, wherein the plurality of auctions are associated with a plurality of different locations.

9. The method of claim 1, further comprising displaying one or more attributes associated with the potential vehicle to the vehicle dealer.

10. A device, comprising:
at least one processor; and
at least one memory storing computer-readable instructions that when executed by the at least one processor, cause the at least one processor to:
receive one or more vehicle purchasing parameters associated with a vehicle seller and one or more inventory parameters associated with an inventory of the vehicle buyer;
receive, in real-time, auction data from a plurality of online vehicle auctions, the auction data associated with one or more vehicles being auctioned at one or more of the plurality of online vehicle auctions;
determine, based at least in part on the one or more vehicle purchasing parameters and the one or more inventory parameters, a subset of the one or more vehicles; and
determine at least one potential vehicle, from the subset, to purchase.

11. The device of claim 10, wherein the at least one memory comprises further instructions that cause the at least one processor to:
determine an online vehicle auction, from the plurality of vehicle auctions, that is auctioning the at least one potential vehicle; and
bid on the at least one potential vehicle for the online vehicle auction.

12. The device of claim 10, wherein the at least one memory comprises further instructions that cause the at least one processor to generate one or more vehicle purchase recommendations based at least in part on the one or more inventory parameters.

13. The device of claim 12, wherein the instructions to filter the auction data based at least in part on the one or more inventory parameters further comprise instructions to filter the auction data based at least in part on the one or more vehicle purchase recommendations.

14. The device of claim 10, wherein the plurality of auctions are hosted by two or more auction entities.

15. The device of claim 10, wherein the one or more inventory parameters comprise at least one of: a sales volume, a market day supply, a retail profitability, or an availability of one or more inventory vehicles associated with the inventory

16. The device of claim 10, wherein the plurality of auctions are associated with a plurality of locations.

17. The device of claim 10, wherein the one or more vehicle purchase parameters comprise at least one of: vehicle type, make, model, color, condition, grade, wholesale price, potential retail price, profit margin, or markup percentage.

18. A non-transitory computer-readable storing instructions, that when executed by one or more processors, cause the at least one or more processors to:
receive one or more vehicle purchasing parameters associated with a vehicle seller and one or more vehicle purchase recommendations associated with an inventory of the vehicle seller;
receive, in real-time, auction data from a plurality of online vehicle auctions hosted by two or more auction entities, the auction data associated with one or more vehicles being auctioned at the plurality of online vehicle auctions;
filter the auction data, based at least in part on the one or more vehicle purchasing parameters and the one or more vehicle purchase recommendations, into a subset of the one or more vehicles; and
determine at least one potential vehicle, from the subset, to purchase.

19. The computer-readable medium of claim 18, further comprising instructions that cause the one or more processors to:
determine an online vehicle auction, from the plurality of vehicle auctions, that is auctioning the at least one potential vehicle; and
bid on the at least one potential vehicle for the online vehicle auction.

20. The computer-readable medium of claim 18, wherein the plurality of auctions are associated with a plurality of locations.
